(19) United States
(12) Patent Application Publication
(10) Pub. No.: US 2010/0277414 A1
(43) Pub. Date: Nov. 4, 2010

(54) KEYBOARD FOR A PORTABLE COMPUTING DEVICE

(75) Inventors: Robert S. Tartz, San Marcos, CA (US); James B. Cary, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/433,280

(22) Filed: Apr. 30, 2009

(51) Int. Cl. G06F 3/02

(52) U.S. Cl. 345/169

(57) ABSTRACT

A method for managing a virtual keyboard is disclosed and may include detecting whether a button is pressed and determining a contact patch size associated with a user digit pressing the button. The method may also include determining a button size associated with the button, determining whether the button size satisfies an optimized condition, querying a user to re-size the button when the button size does not satisfy the optimized condition, and automatically re-sizing the button so the button size satisfies the optimized condition. Further, the method may include querying a user to re-size all buttons and automatically re-sizing all buttons based on an optimized button size.

### FIELD

The present invention generally relates to the portable computing devices, and more particularly, to portable computing device keyboards.

### DESCRIPTION OF THE RELATED ART

Portable computing devices (PCDs) are ubiquitous. These devices may include cellular telephones, portable digital assistants (PDAs), portable game consoles, palmtop computers, and other portable electronic devices. Many portable computing devices include a keyboard, either a mechanical keyboard, a virtual keyboard, or a combination thereof. Virtual keyboards may be presented via a touch screen display and may be used to input text, numbers, and other characters to the portable computing device. Oftentimes, these keyboards may be difficult to use. Further, the virtual keyboards may occupy too much screen and may detract from the user experience when using a portable computing device.

Accordingly, what is needed is an improved keyboard for a PCD.

### SUMMARY OF THE DISCLOSURE

A keyboard for a portable computing device (PCD) is disclosed and may include a first quadrantal portion disposed on a left side of a central axis, wherein the first quadrantal portion spans approximately zero degrees to approximately ninety degrees and wherein the first quadrantal portion comprises a first plurality of keyboard buttons and a second quadrantal portion disposed on a right side of a central axis, wherein the second quadrantal portion spans approximately ninety degrees to one hundred eighty degrees and wherein the second quadrantal portion comprises a second plurality of keyboard buttons.

In a particular aspect, the first plurality of keyboard buttons within the first quadrantal portion may be arranged in a first plurality of arced button rows and the second plurality of keyboard buttons within the second quadrantal portion may be arranged in a second plurality of arced button rows. Further, the first plurality of arced button rows may be concentric around a vertex of the first quadrantal portion and the second plurality of arced button rows may be concentric around a vertex of the second quadrantal portion.

The first plurality of arced button rows may include a first arced button row, a second arced button row, a third arced button row, a fourth arced button row, a fifth arced button, a sixth arced button row, or a combination thereof. The first arced button row may include a first button labeled “ENTER”. The second arced button row may include a first button labeled “!@*” and a second button labeled “SHIFT”. The third arced button row may include a first button labeled “Z”, a second button labeled “X”, a third button labeled “C”, and a fourth button labeled “V”. The fourth arced button row may include a first button labeled “A”, a second button labeled “S”, a third button labeled “D”, a fourth button labeled “F”, and a fifth button labeled “G”. The fifth arced button row may include a first button labeled “Q”, a second button labeled “W”, a third button labeled “E”, a fourth button labeled “R”, and a fifth button labeled “T”. Further, the sixth arced button row may include a first button labeled “1”, a second button labeled “2”, a third button labeled “3”, a fourth button labeled “4” and a fifth button labeled “5”; or any combination thereof. In this aspect, the first quadrantal portion may include a first space button.

The second plurality of arced button rows may include a first arced button row, a second arced button row, a third arced button row, a fourth arced button row, a fifth arced button, a sixth arced button row, or a combination thereof. The first arced button row may include a first button labeled “ENTER”. The second arced button row may include a first button labeled “SHIFT” and a second button labeled “FUNC”. The third arced button row may include a first button labeled “B”, a second button labeled “N”, a third button labeled “M”, and a fourth button labeled “RETURN”. The fourth arced button row may include a first button labeled “H”, a second button labeled “J”, a third button labeled “K”, a fourth button labeled “L”, and a fifth button labeled “CLEAR”. The fifth arced button row may include a first button labeled “Y”, a second button labeled “U”, a third button labeled “I”, a fourth button labeled “O”, and a fifth button labeled “P”. Moreover, the sixth arced button row may include a first button labeled “6”, a second button labeled “7”, a third button labeled “8”, a fourth button labeled “9” and a fifth button labeled “0”; or any combination thereof. In this aspect, the second quadrantal portion may include a second space button.

In a particular aspect, the keyboard may be a virtual keyboard and the first plurality of keyboard buttons may include a first plurality of soft buttons and the second plurality of keyboard buttons may include a second plurality of soft buttons. Further, in this aspect, the keyboard may be movable between a maximized configuration in which all soft buttons are displayed and a minimized configuration in which a portion of soft buttons are displayed.

In another aspect, the keyboard may be a mechanical keyboard and the first plurality of keyboard buttons may include a first plurality of mechanical buttons and wherein the second plurality of keyboard buttons may include a second plurality of mechanical buttons. In this aspect, the keyboard may also include a space button between the first quadrantal portion and the second quadrantal portion. Additionally, the keyboard may include a mouse pad between the first quadrantal portion and the second quadrantal portion.

In another aspect, a method for managing a virtual keyboard is disclosed and may include detecting whether a button is pressed and determining a contact patch size associated with a user digit pressing the button. The method may also include determining a button size associated with the button, determining whether the button size satisfies an optimized condition, querying a user to re-size the button when the button size does not satisfy the optimized condition, and automatically re-sizing the button so the button size satisfies the optimized condition. Further, the method may include querying a user to re-size all buttons and automatically re-sizing all buttons based on an optimized button size.

In a particular aspect, the method may include comparing the contact patch size to the button size in order to determine whether the button size satisfies the optimized condition. The button size may be optimized when the button size is at least same as the contact patch size. Further, the button size may be optimized when the button size is no greater than one and one-half times the contact patch size.

In yet another aspect, a portable computing device is disclosed and may include means for detecting whether a button is pressed and means for determining a contact patch size associated with a user digit pressing the button. The portable computing device may also include means for determining a button size associated with the button, means for determining whether the button size satisfies an optimized condition, means for querying a user to re-size the button when the button size does not satisfy the optimized condition, and means for automatically re-sizing the button so the button size satisfies the optimized condition. Further, the portable computing device may include means for querying a user to re-size all buttons and means for automatically re-sizing all buttons based on an optimized button size.

In a particular aspect, the portable computing device may include means for comparing the contact patch size to the button size in order to determine whether the button size satisfies the optimized condition. The button size may be optimized when the button size is at least same as the contact patch size. Further, the button size may be optimized when the button size is no greater than one and one-half times the contact patch size.

In still another aspect, a portable computing device is disclosed and may include a processor that may be operable to detect whether a button is pressed and determine a contact patch size associated with a user digit pressing the button. The processor may be further operable to determine a button size associated with the button, determine whether the button size satisfies an optimized condition, query a user to re-size the button when the button size does not satisfy the optimized condition, and automatically re-size the button so the button size satisfies the optimized condition. Further, the processor may be operable to query a user to re-size all buttons and automatically re- size all buttons based on an optimized button size.

In a particular aspect, the processor may be operable to compare the contact patch size to the button size in order to determine whether the button size satisfies the optimized condition. The button size may be optimized when the button size is at least same as the contact patch size. Further, the button size may be optimized when the button size is no greater than one and one-half times the contact patch size.

In yet another aspect, a computer program product is disclosed and may include a computer-readable medium. The computer-readable medium may include at least one instruction for detecting whether a button is pressed and at least one instruction for determining a contact patch size associated with a user digit pressing the button. The computer-readable medium may also include at least one instruction for determining a button size associated with the button, at least one instruction for determining whether the button size satisfies an optimized condition, at least one instruction for querying a user to re-size the button when the button size does not satisfy the optimized condition, and at least one instruction for automatically re-sizing the button so the button size satisfies the optimized condition. Further, the computer-readable medium may include at least one instruction for querying a user to re-size all buttons and at least one instruction for automatically re-sizing all buttons based on an optimized button size.

In a particular aspect, the computer-readable medium may include at least one instruction for comparing the contact patch size to the button size in order to determine whether the button size satisfies the optimized condition. The button size may be optimized when the button size is at least same as the contact patch size. Further, the button size may be optimized when the button size is no greater than one and one-half times the contact patch size.

### BRIEF DESCRIPTION OF THE DRAWINGS

In the figures, like reference numerals refer to like parts throughout the various views unless otherwise indicated.

FIG. 1 is a front plan view of a portable computing device (PCD) in a closed position;

FIG. 2 is a front plan view of a PCD in an open position;

FIG. 3 is a plan view of a first aspect of a keyboard in a maximized configuration;

FIG. 4 is a plan view of the first aspect of a keyboard in a minimized configuration;

FIG. 5 is a plan view of a second aspect of a keyboard in a maximized configuration;

FIG. 6 is a plan view of the second aspect of a keyboard in a minimized configuration;

FIG. 7 is a front plan view of a second aspect of a PCD in an open position;

FIG. 8 is a front plan view of a third aspect of a PCD in an open position;

FIG. 9 is a block diagram of a PCD;

FIG. 10 is a first portion of a flowchart illustrating a method of managing a virtual keyboard;

FIG. 11 is a second portion of the flowchart illustrating a method of managing a virtual keyboard; and

FIG. 12 is a third portion of the flowchart illustrating a method of managing a virtual keyboard.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

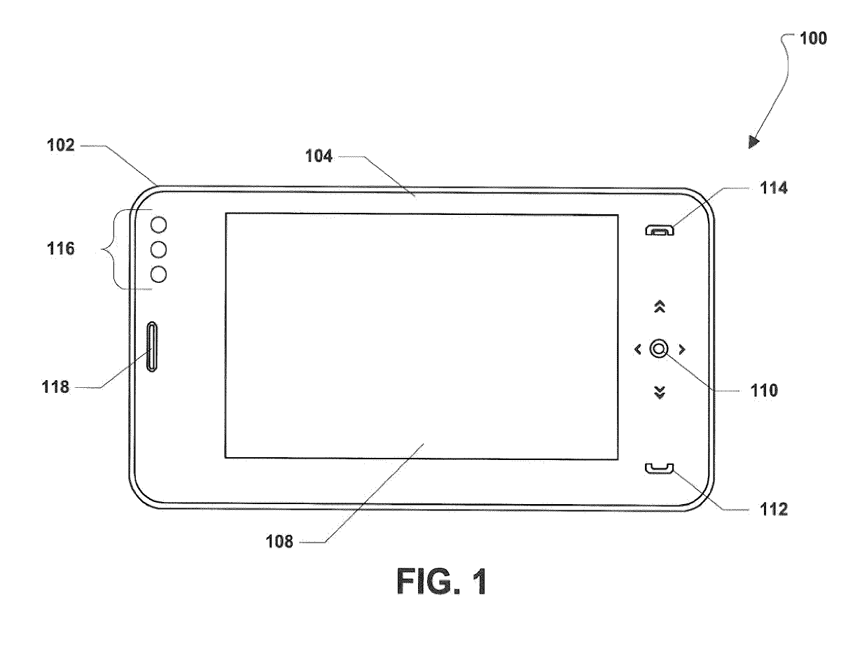

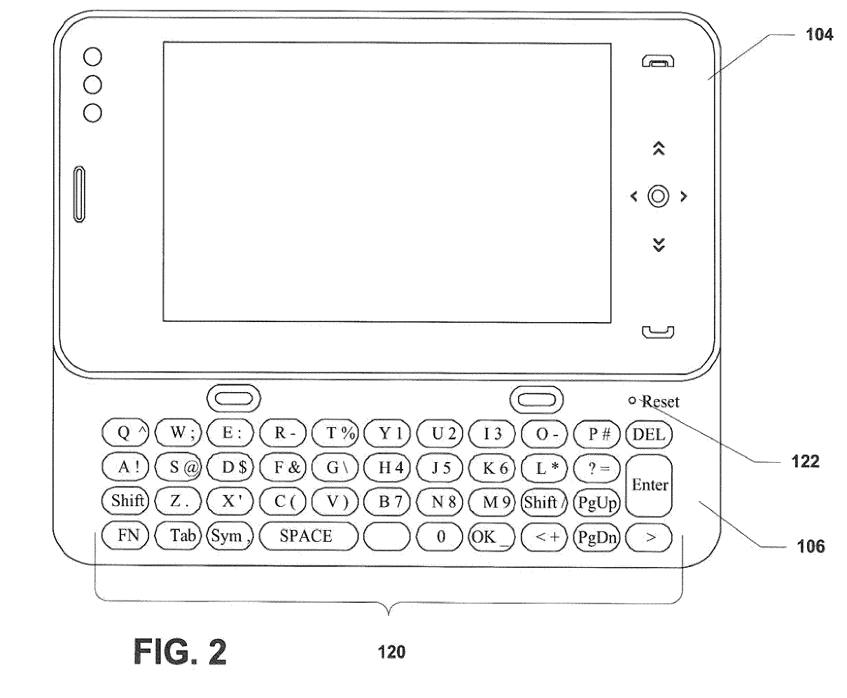

Referring initially to FIG. 1 and FIG. 2, an exemplary portable computing device (PCD) is shown and is generally designated 100. As shown, the PCD 100 may include a housing 102. The housing 102 may include an upper housing portion 104 and a lower housing portion 106. FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

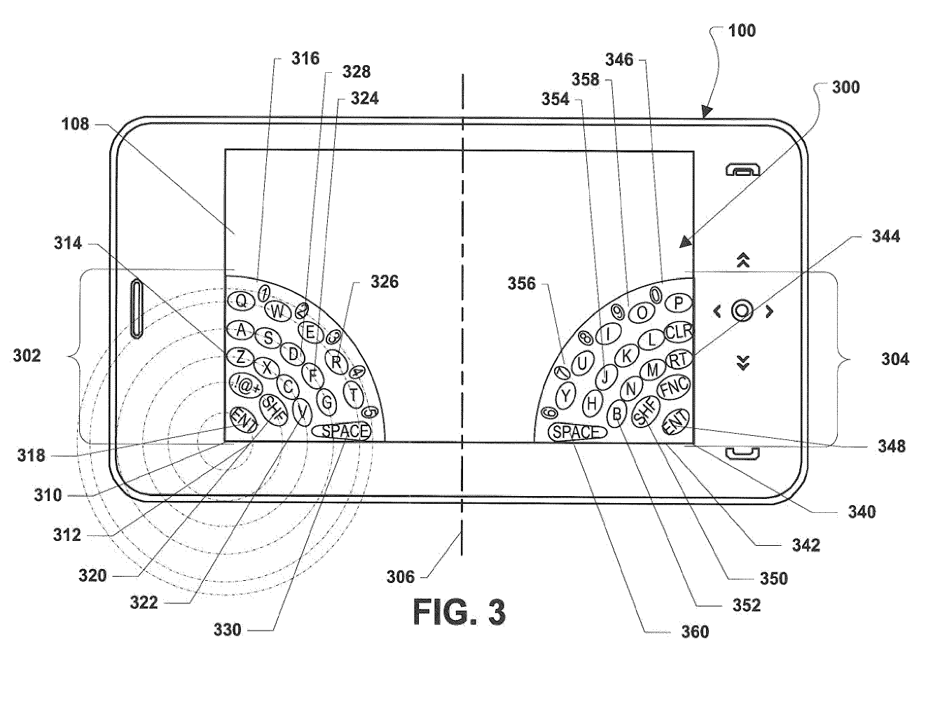

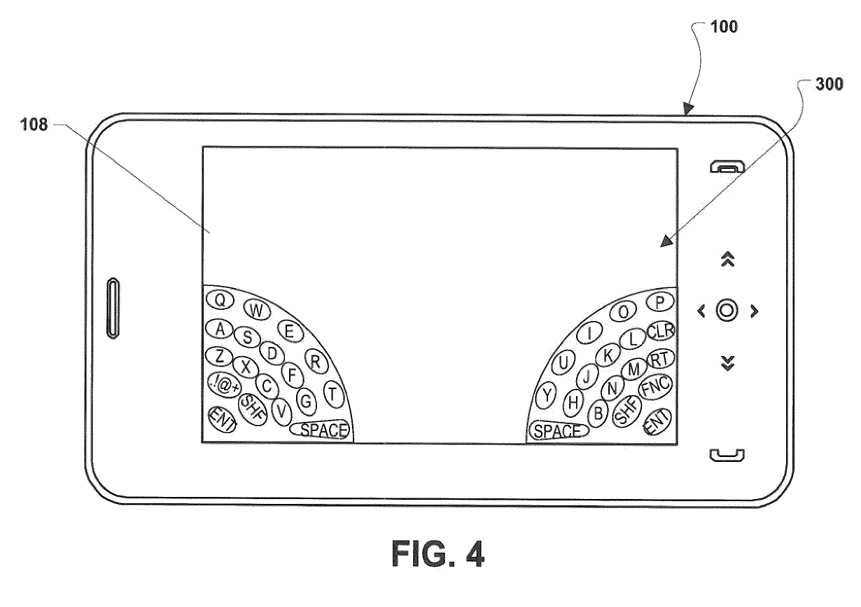

Referring now to FIG. 3 and FIG. 4, a first aspect of a virtual keyboard is shown and is generally designated 300. In this aspect, the virtual keyboard 300 may be displayed on a PCD, e.g., the PCD 100 shown in FIG. 1 and FIG. 2. The virtual keyboard 300 may include a first quadrantal portion 302 and a second quadrantal portion 304. In a particular aspect, the first quadrantal portion 302 may be located to the left of a central axis 306 and the second quadrantal portion 304 may be located to the right of the central axis 306.

As shown in FIG. 3, the first quadrantal portion 302 may include a vertex 3 10. A first straight side 312 may extend from the vertex 310 at approximately zero degrees (0°). A second straight side 314 may extend from the vertex 310 at approximately ninety degrees (90°). An arced side 316 may extend between an end of the first straight side 312 and an end of the second straight side 314. Accordingly, the first quadrantal portion 302 may be a quarter of a circle and may span an area from zero degrees (0°) to ninety degrees (9°).

As shown, the vertex 310 of the first quadrantal portion 302 may be substantially aligned with a lower left corner of the display 108 on the PCD 100. Further, the first straight side 312 of the first quadrantal portion 302 may extend partially along a bottom edge of the display 108 of the PCD 100. Also, the second straight side 314 of the first quadrantal portion 302 may extend partially along a left edge of the display 108 of the PCD 100.

FIG. 3 indicates that the first quadrantal portion 302 of the virtual keyboard 300 may include a plurality of buttons, i.e., soft keys. The plurality of buttons may be arranged within a first arced button row 318, a second arced button row 320, a third arced button row 322, a fourth arced button row 324, a fifth arced button row 326, and a sixth arced button row 328. As shown, the arced button rows 318, 320, 322, 324, 324, 326, 328 may be concentrically located around the vertex 310 of the first quadrantal portion 302 as indicated by the dashed circles.

In a particular aspect, each of the plurality of buttons may be labeled with a number, a character, a symbol, or a combination thereof. For example, the first arced button row 318 may include a first button labeled “ENTER”. The second arced button row 320 may include a first button labeled “!@*” and a second button labeled “SHIFT”. The third arced button row 322 may include a first button labeled “Z”, a second button labeled “X”, a third button labeled “C”, and a fourth button labeled “V”. The fourth arced button row 324 may include a first button labeled “A”, a second button labeled “S”, a third button labeled “D”, a fourth button labeled “F”, and a fifth button labeled “G”. The fifth arced button row 326 may include a first button labeled “Q”, a second button labeled “W”, a third button labeled “E”, a fourth button labeled “R”, and a fifth button labeled “T”. Also, the sixth arced button row 328 may include a first button labeled “1”, a second button labeled “2”, a third button labeled “3”, a fourth button labeled “4” and a fifth button labeled “5”. As shown, the first quadrantal portion 302 of the virtual keyboard 300 may also include a first space button 330.

As illustrated in FIG. 3, the second quadrantal portion 304 may include a vertex 340. A first straight side 342 may extend from the vertex 340 at approximately one hundred eighty degrees (180°). A second straight side 344 may extend from the vertex 340 at approximately ninety degrees (90°). An arced side 346 may extend between an end of the first straight side 342 and an end of the second straight side 344. Accordingly, the second quadrantal portion 304 may be a quarter of a circle and may span an area from ninety degrees (90°) to one hundred eighty degrees (180°).

As shown, the vertex 340 of the second quadrantal portion 304 may be substantially aligned with a lower right corner of the display 108 on the PCD 100. Further, the first straight side 342 of the second quadrantal portion 304 may extend partially along a bottom edge of the display 108 of the PCD 100. Also, the second straight side 344 of the second quadrantal portion 304 may extend partially along a right edge of the display 108 of the PCD 100.

FIG. 3 shows that the second quadrantal portion 304 of the virtual keyboard 300 may include a plurality of buttons, i.e., soft keys. The plurality of buttons may be arranged within a first arced button row 348, a second arced button row 350, a third arced button row 352, a fourth arced button row 354, a fifth arced button row 356, and a sixth arced button row 358. As shown, the arced button rows 348, 350, 352, 354, 354, 356, 358 may be concentrically located around the vertex 340 of the second quadrantal portion 304 as indicated by the dashed circles.

In a particular aspect, each of the plurality of buttons may be labeled with a number, a character, a symbol, or a combination thereof. For example, the first arced button row 348 may include a first button labeled “ENTER”. The second arced button row 350 may include a first button labeled “SHIFT” and a second button labeled “FUNC”. The third arced button row 352 may include a first button labeled “B”, a second button labeled “N”, a third button labeled “M”, and a fourth button labeled “RETURN”. The fourth arced button row 354 may include a first button labeled “H”, a second button labeled “J”, a third button labeled “K”, a fourth button labeled “L”, and a fifth button labeled “CLEAR”. The fifth arced button row 356 may include a first button labeled “Y”, a second button labeled “U”, a third button labeled “I”, a fourth button labeled “O”, and a fifth button labeled “P”. Also, the sixth arced button row 358 may include a first button labeled “6”, a second button labeled “7”, a third button labeled “8”, a fourth button labeled “9” and a fifth button labeled “0”. As shown, the second quadrantal portion 304 of the virtual keyboard 300 may also include a second space button 360.

In a particular aspect, when each button is pressed, the text, number, or character corresponding to the respective button may be presented on the display 108. The case of any letter may be altered by pressing a shift button before pressing a selected button. Further, in a particular aspect, the virtual keyboard 300 may be moved between a maximized configuration shown in FIG. 3 and a minimized configuration shown in FIG. 4. In the maximized configuration, all arced button rows 318, 320, 322, 324, 326, 328, 348, 350, 352, 354, 356, 358 within each quadrantal portion 302, 304 may be presented to the user. In the minimized configuration, one or more arced button rows 318, 320, 322, 324, 326, 328, 348, 350, 352, 354, 356, 358 may not be presented to the user. For example, as shown in FIG. 4, in the minimized configuration, the sixth arced button row 328, 358 on each quadrantal portion 302, 304 may not be presented to the user. The minimized configuration may be displayed when a user is seeking to minimize blocking content displayed at the display 108. A user may move the virtual keyboard between the maximized configuration and the minimized configuration by dragging a corner of either quadrantal portion 302, 304. The quadrantal portions 302, 304 may move between the maximized configuration and the minimized configuration separately or in unison.

In a particular aspect, as described herein, button sizes may be automatically optimized based on a size of a user's digit (finger or thumb), i.e., a size of a contact patch of the user's digit with the touch screen display 108. Alternatively, button sizes may be manually changed. A user may select a button and then, select a button size associated with the button. Each button may have several sizes, e.g., small, medium, large, etc. Alternatively, each button may have an infinite number of sizes between a smallest sized and a largest size. A button size may be altered by selecting a button and then, dragging a corner of a button or by dragging a slider associated with a button. All button sizes may be changed simultaneously by changing a size of a quadrantal portion 302, 304 of the virtual keyboard 300.

In another aspect, the location of the first quadrantal portion 302 or the location of the second quadrantal portion 304 within the touch screen display 108 may be altered by dragging either the first quadrantal portion 302 or the second quadrantal portion 304 within the touch screen display 108. Further, by dragging the first quadrantal portion 302 onto the second quadrantal portion 304, or by dragging the second quadrantal portion 304 onto the first quadrantal portion 302, the virtual keyboard 300 may revert to a one-piece, generally rectangular QWERTY keyboard.

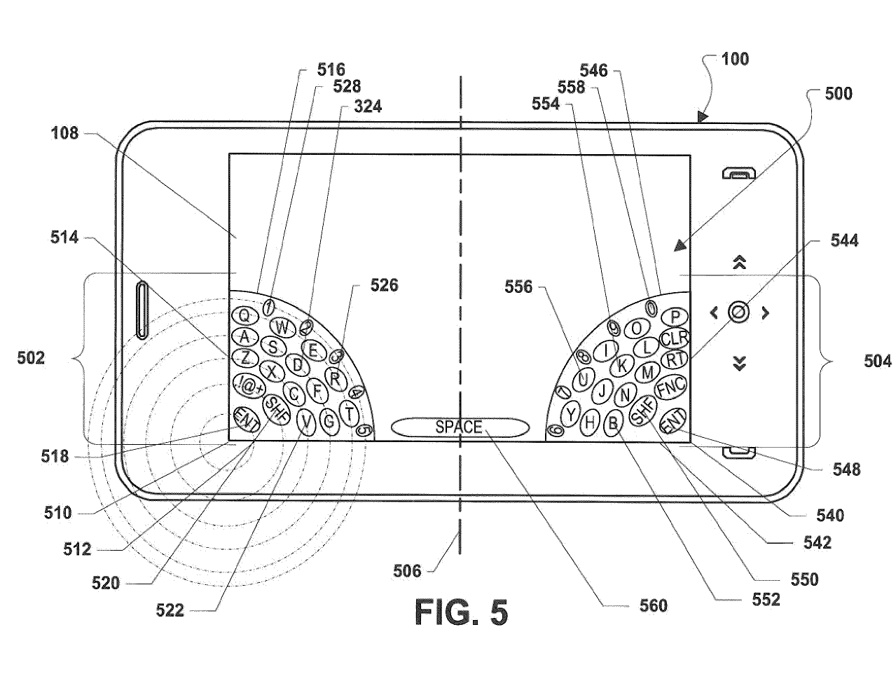

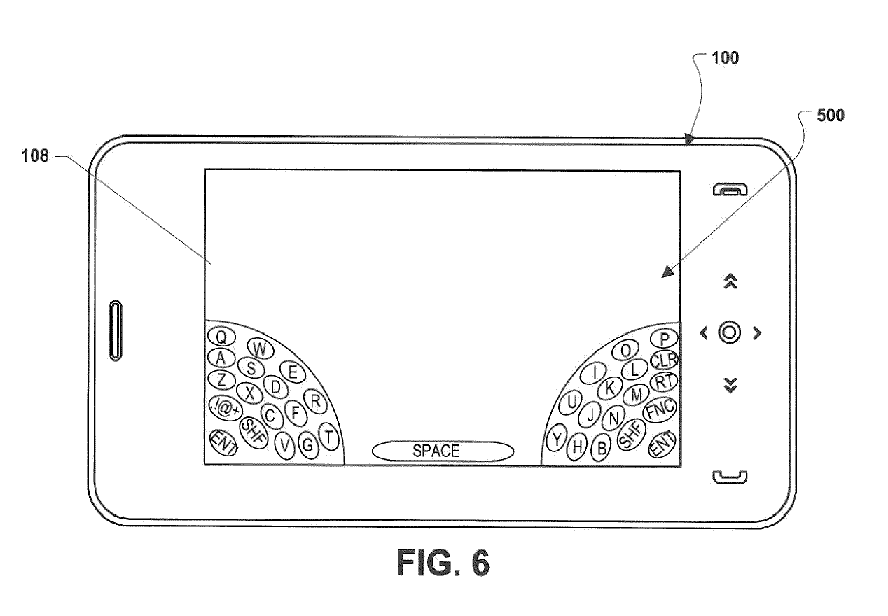

FIG. 5 and FIG. 6 illustrate a second aspect of a virtual keyboard, generally designated 500. The virtual keyboard 500 may be displayed on a PCD, e.g., the PCD 100 shown in FIG. 1 and FIG. 2. The virtual keyboard 300 may include a first quadrantal portion 502 and a second quadrantal portion 504. In a particular aspect, the first quadrantal portion 502 may be located to the left of a central axis 506 and the second quadrantal portion 504 may be located to the right of the central axis 506.

As shown in FIG. 5 and FIG. 6, the first quadrantal portion 502 may include a vertex 510. A first straight side 512 may extend from the vertex 510 at approximately zero degrees (0°). A second straight side 514 may extend from the vertex 510 at approximately ninety degrees (90°). An arced side 516 may extend between an end of the first straight side 512 and an end of the second straight side 514. Accordingly, the first quadrantal portion 502 may be a quarter of a circle and may span an area from zero degrees (0°) to ninety degrees (90°).

As shown, the vertex 510 of the first quadrantal portion 502 may be substantially aligned with a lower left corner of the display 108 on the PCD 100. Further, the first straight side 512 of the first quadrantal portion 502 may extend partially along a bottom edge of the display 108 of the PCD 100. Also, the second straight side 514 of the first quadrantal portion 502 may extend partially along a left edge of the display 108 of the PCD 100.

FIG. 5 indicates that the first quadrantal portion 502 of the virtual keyboard 500 may include a plurality of buttons, i.e., soft keys. The plurality of buttons may be arranged within a first arced button row 518, a second arced button row 520, a third arced button row 522, a fourth arced button row 524, a fifth arced button row 526, and a sixth arced button row 528. As shown, the arced button rows 518, 520, 522, 524, 524, 526, 528 may be concentrically located around the vertex 510 of the first quadrantal portion 502 as indicated by the dashed circles.

In a particular aspect, each of the plurality of buttons may be labeled with a number, a character, a symbol, or a combination thereof. For example, the first arced button row 518 may include a first button labeled “ENTER”. The second arced button row 520 may include a first button labeled “!@*” and a second button labeled “SHIFT”. The third arced button row 522 may include a first button labeled “Z”, a second button labeled “X”, a third button labeled “C”, and a fourth button labeled “V”. The fourth arced button row 524 may include a first button labeled “A”, a second button labeled “S”, a third button labeled “D”, a fourth button labeled “F”, and a fifth button labeled “G”. The fifth arced button row 526 may include a first button labeled “Q”, a second button labeled “W”, a third button labeled “E”, a fourth button labeled “R”, and a fifth button labeled “T”. Also, the sixth arced button row 528 may include a first button labeled “1”, a second button labeled “2”, a third button labeled “3”, a fourth button labeled “4” and a fifth button labeled “5”.

As illustrated in FIG. 5, the second quadrantal portion 504 may include a vertex 540. A first straight side 542 may extend from the vertex 540 at approximately one hundred eighty degrees (180°). A second straight side 544 may extend from the vertex 540 at approximately ninety degrees (90°). An arced side 546 may extend between an end of the first straight side 542 and an end of the second straight side 544. Accordingly, the second quadrantal portion 504 may be a quarter of a circle and may span an area from ninety degrees (90°) to one hundred eighty degrees (180°).

As shown, the vertex 540 of the second quadrantal portion 504 may be substantially aligned with a lower right corner of the display 108 on the PCD 100. Further, the first straight side 542 of the second quadrantal portion 504 may extend partially along a bottom edge of the display 108 of the PCD 100. Also, the second straight side 544 of the second quadrantal portion 504 may extend partially along a right edge of the display 108 of the PCD 100.

FIG. 5 shows that the second quadrantal portion 504 of the virtual keyboard 500 may include a plurality of buttons, i.e., soft keys. The plurality of buttons may be arranged within a first arced button row 548, a second arced button row 550, a third arced button row 552, a fourth arced button row 554, a fifth arced button row 556, and a sixth arced button row 558. As shown, the arced button rows 548, 550, 552, 554, 554, 556, 558 may be concentrically located around the vertex 540 of the second quadrantal portion 504 as indicated by the dashed circles.

In a particular aspect, each of the plurality of buttons may be labeled with a number, a character, a symbol, or a combination thereof. For example, the first arced button row 548 may include a first button labeled “ENTER”. The second arced button row 550 may include a first button labeled “SHIFT” and a second button labeled “FUNC”. The third arced button row 552 may include a first button labeled “B”, a second button labeled “N”, a third button labeled “M”, and a fourth button labeled “RETURN”. The fourth arced button row 554 may include a first button labeled “H”, a second button labeled “J”, a third button labeled “K”, a fourth button labeled “L”, and a fifth button labeled “CLEAR”. The fifth arced button row 556 may include a first button labeled “Y”, a second button labeled “U”, a third button labeled “I”, a fourth button labeled “O”, and a fifth button labeled “P”. Also, the sixth arced button row 558 may include a first button labeled “6”, a second button labeled “7”, a third button labeled “8”, a fourth button labeled “9” and a fifth button labeled “0”.

As illustrated in FIG. 5 and FIG. 6, the virtual keyboard 500 may include a space button 560 between the first quadrantal portion 502 and the second quadrantal portion 504. A user may select the space button 560 using either thumb.

In a particular aspect, the virtual keyboard 500 may be moved between a maximized configuration shown in FIG. 5 and a minimized configuration shown in FIG. 6. In the maximized configuration, all arced button rows 518, 520, 522, 524, 526, 528, 548, 550, 552, 554, 556, 558 within each quadrantal portion 502, 504 may be presented to the user. In the minimized configuration, one or more arced button rows 518, 520, 522, 524, 526, 528, 548, 550, 552, 554, 556, 558 may not be presented to the user. For example, as shown in FIG. 6, in the minimized configuration, the sixth arced button row 528, 558 on each quadrantal portion 502, 504 may not be presented to the user. The minimized configuration may be displayed when a user is seeking to minimize blocking content displayed at the display 108. A user may move the virtual keyboard between the maximized configuration and the minimized configuration by dragging a corner of either quadrantal portion 502, 504. The quadrantal portions 502, 504 may move between the maximized configuration and the minimized configuration separately or in unison.

In a particular aspect, as described herein, button sizes may be automatically optimized based on a size of a user's finger, i.e., a size of a contact patch of the user's finger with the touch screen display 108. Alternatively, button sizes may be manually changed. A user may select a button and then, select a button size associated with the button. Each button may have several sizes, e.g., small, medium, large, etc. Alternatively, each button may have an infinite number of sizes between a smallest sized and a largest size. A button size may be altered by selecting a button and then, dragging a corner of a button or by dragging a slider associated with a button. All button sizes may be changed simultaneously by changing a size of a quadrantal portion 502, 504 of the virtual keyboard 500.

In another aspect, the location of the first quadrantal portion 502 or the location of the second quadrantal portion 504 within the touch screen display 108 may be altered by dragging either the first quadrantal portion 502 or the second quadrantal portion 504 within the touch screen display 108. Further, by dragging the first quadrantal portion 502 onto the second quadrantal portion 504, or by dragging the second quadrantal portion 504 onto the first quadrantal portion 502, the virtual keyboard 500 may revert to a one-piece, generally rectangular QWERTY keyboard.

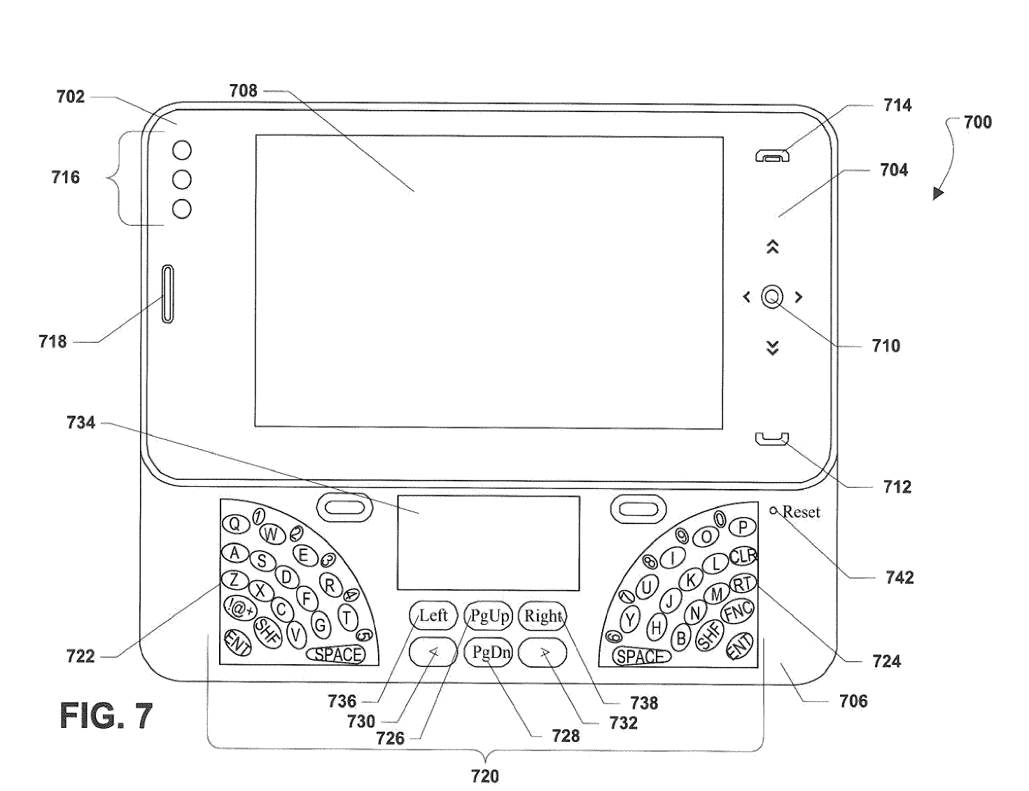

FIG. 7 illustrates a second aspect of a portable computing device (PCD), generally designated 700. As shown, the PCD 700 may include a housing 702. The housing 702 may include an upper housing portion 704 and a lower housing portion 706. FIG. 7 shows that the upper housing portion 704 may include a display 708. In a particular aspect, the display 708 may be a touch screen display. The upper housing portion 704 may also include a trackball input device 710. Further, as shown in FIG. 7, the upper housing portion 704 may include a power on button 712 and a power off button 714. As shown in FIG. 7, the upper housing portion 704 of the PCD 700 may include a plurality of indicator lights 716 and a speaker 718. Each indicator light 716 may be a light emitting diode (LED).

In a particular aspect, the upper housing portion 704 is movable relative to the lower housing portion 706. Specifically, the upper housing portion 704 may be slidable relative to the lower housing portion 706. As shown in FIG. 7, the lower housing portion 706 may include a multi-button keyboard 720. The multi-button keyboard 720 may be revealed when the upper housing portion 704 is moved relative to the lower housing portion 706.

As illustrated, the multi-button keyboard 720 may include a first quadrantal portion 722 and a second quadrantal portion 724. The first quadrantal portion 722 may be configured similar to the first quadrantal portion 302 described in conjunction with FIG. 3. However, the buttons that make up the first quadrantal portion 722 are mechanical buttons and not soft keys, as described in conjunction with FIG. 3. The second quadrantal portion 724 may be configured similar to the second quadrantal portion 304 described in conjunction with FIG. 3. Again, the buttons that make up the second quadrantal portion 724 are mechanical buttons and not soft keys, as described above in conjunction with FIG. 3.

As shown in FIG. 7, the lower housing portion 708 may further include a page up button 726, a page down button 728, a forward button 730, and a back button 732. Also, the lower housing portion 708 may include a mouse pad 734, a left mouse button 736, and a right mouse button 738. The PCD 700 may include a reset button 742 on the lower housing portion 706.

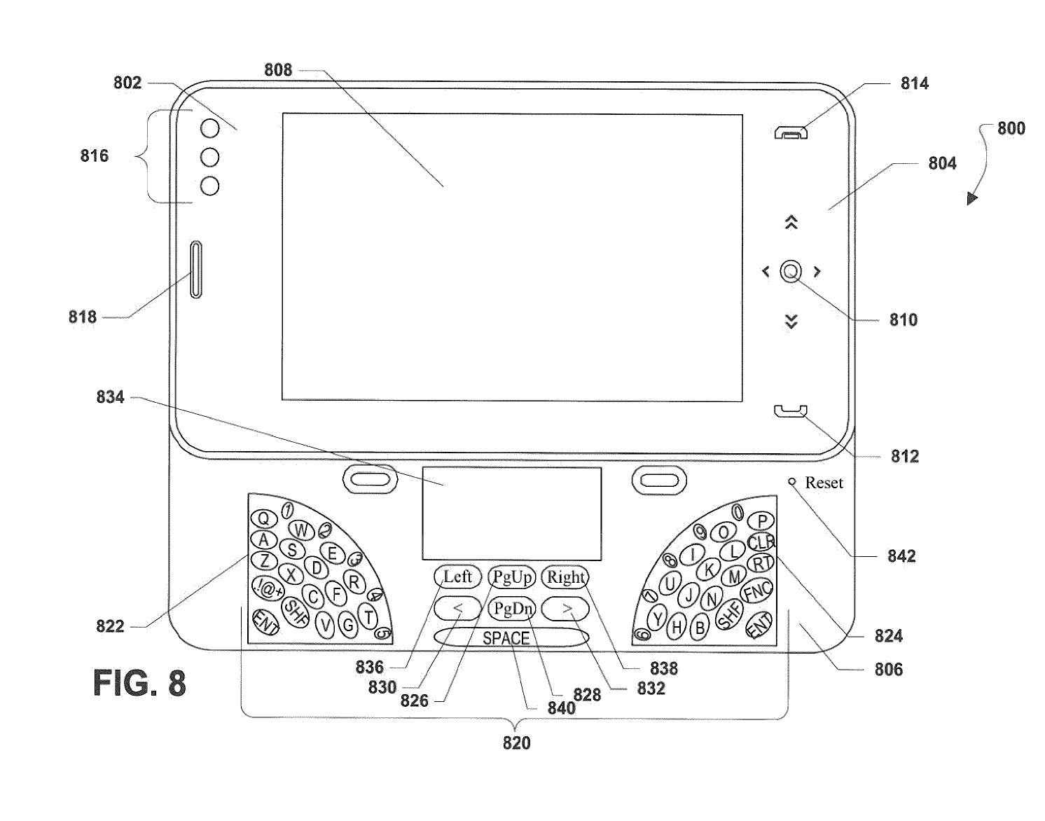

Referring now to FIG. 8, a third aspect of a portable computing device (PCD) is illustrated and is generally designated 800. As shown, the PCD 800 may include a housing 802. The housing 802 may include an upper housing portion 804 and a lower housing portion 806. FIG. 8 shows that the upper housing portion 804 may include a display 808. In a particular aspect, the display 808 may be a touch screen display. The upper housing portion 804 may also include a trackball input device 810. Further, as shown in FIG. 8, the upper housing portion 804 may include a power on button 812 and a power off button 814. As shown in FIG. 8, the upper housing portion 804 of the PCD 800 may include a plurality of indicator lights 816 and a speaker 818. Each indicator light 816 may be a light emitting diode (LED).

In a particular aspect, the upper housing portion 804 is movable relative to the lower housing portion 806. Specifically, the upper housing portion 804 may be slidable relative to the lower housing portion 806. As shown in FIG. 8, the lower housing portion 806 may include a multi-button keyboard 820. The multi-button keyboard 820 may be revealed when the upper housing portion 804 is moved relative to the lower housing portion 806.

As illustrated, the multi-button keyboard 820 may include a first quadrantal portion 822 and a second quadrantal portion 824. The first quadrantal portion 822 may be configured similar to the first quadrantal portion 302 described in conjunction with FIG. 3. However, the buttons that make up the first quadrantal portion 822 are mechanical buttons and not soft keys, as described in conjunction with FIG. 3. The second quadrantal portion 824 may be configured similar to the second quadrantal portion 304 described in conjunction with FIG. 3. Again, the buttons that make up the second quadrantal portion 824 are mechanical buttons and not soft keys, as described above in conjunction with FIG. 3.

As shown in FIG. 8, the lower housing portion 808 may further include a page up button 826, a page down button 828, a forward button 830, and a back button 832. Also, the lower housing portion 808 may include a mouse pad 834, a left mouse button 836, and a right mouse button 838. As indicated, the lower housing portion 808 may include a space button 840 between the first quadrantal portion 822 of the keyboard 820 and the second quadrantal portion 824 of the keyboard 820. The PCD 800 may include a reset button 842 on the lower housing portion 806.

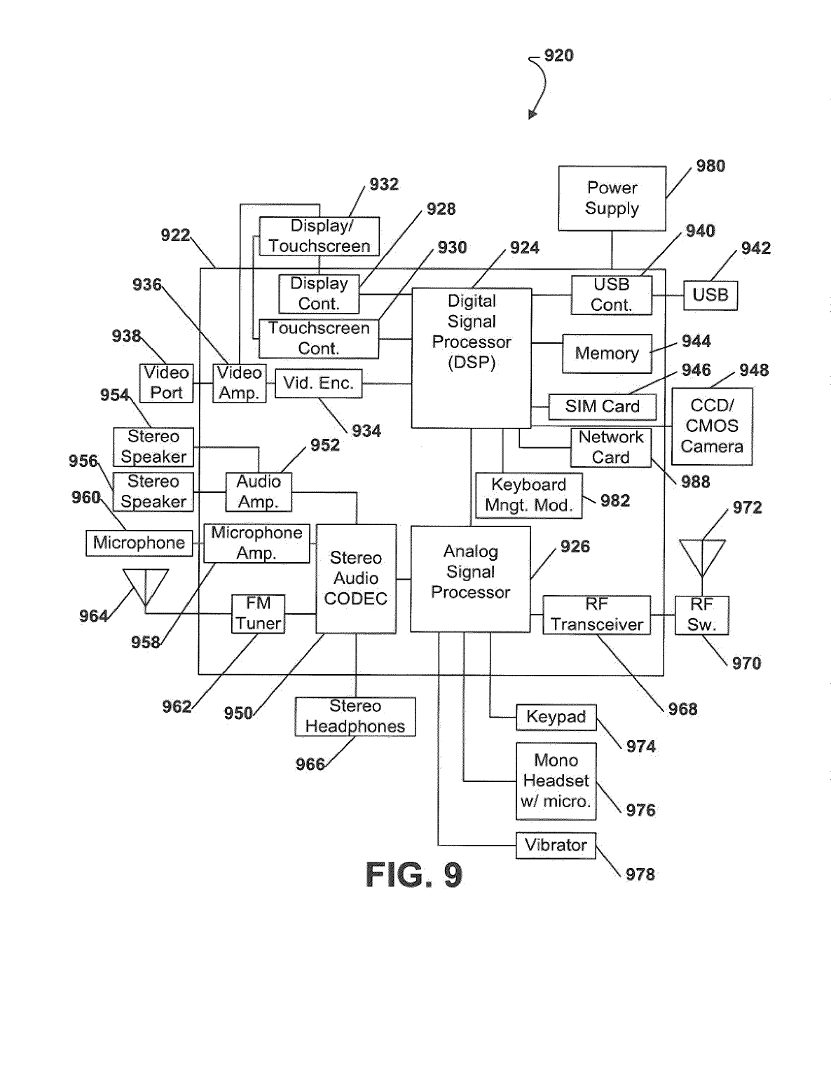

Referring to FIG. 9, an exemplary, non-limiting aspect of a portable computing device (PCD) is shown and is generally designated 920. As shown, the PCD 920 includes an on-chip system 922 that includes a digital signal processor 924 and an analog signal processor 926 that are coupled together. The on-chip system 922 may include more than two processors. For example, the on-chip system 922 may include four core processors and an ARM 11 processor, i.e., as described below in conjunction with FIG. 32.

As illustrated in FIG. 9, a display controller 928 and a touch screen controller 930 are coupled to the digital signal processor 924. In turn, a touch screen display 932 external to the on-chip system 922 is coupled to the display controller 928 and the touch screen controller 930.

FIG. 9 further indicates that a video encoder 934, e.g., a phase alternating line (PAL) encoder, a sequential couleur a memoire (SECAM) encoder, or a national television system(s) committee (NTSC) encoder, is coupled to the digital signal processor 924. Further, a video amplifier 936 is coupled to the video encoder 934 and the touch screen display 932. Also, a video port 938 is coupled to the video amplifier 936. As depicted in FIG. 9, a universal serial bus (USB) controller 940 is coupled to the digital signal processor 924. Also, a USB port 942 is coupled to the USB controller 940. A memory 944 and a subscriber identity module (SIM) card 946 may also be coupled to the digital signal processor 924. Further, as shown in FIG. 9, a digital camera 948 may be coupled to the digital signal processor 924. In an exemplary aspect, the digital camera 948 is a charge-coupled device (CCD) camera or a complementary metal-oxide semiconductor (CMOS) camera.

As further illustrated in FIG. 9, a stereo audio CODEC 950 may be coupled to the analog signal processor 926. Moreover, an audio amplifier 952 may coupled to the stereo audio CODEC 950. In an exemplary aspect, a first stereo speaker 954 and a second stereo speaker 956 are coupled to the audio amplifier 952. FIG. 9 shows that a microphone amplifier 958 may be also coupled to the stereo audio CODEC 950. Additionally, a microphone 960 may be coupled to the microphone amplifier 958. In a particular aspect, a frequency modulation (FM) radio tuner 962 may be coupled to the stereo audio CODEC 950. Also, an FM antenna 964 is coupled to the FM radio tuner 962. Further, stereo headphones 966 may be coupled to the stereo audio CODEC 950.

FIG. 9 further indicates that a radio frequency (RF) transceiver 968 may be coupled to the analog signal processor 926. An RF switch 970 may be coupled to the RF transceiver 968 and an RF antenna 972. As shown in FIG. 9, a keypad 974 may be coupled to the analog signal processor 926. Also, a mono headset with a microphone 976 may be coupled to the analog signal processor 926. Further, a vibrator device 978 may be coupled to the analog signal processor 926. FIG. 9 also shows that a power supply 980 may be coupled to the on-chip system 922. In a particular aspect, the power supply 980 is a direct current (DC) power supply that provides power to the various components of the PCD 920 that require power. Further, in a particular aspect, the power supply is a rechargeable DC battery or a DC power supply that is derived from an alternating current (AC) to DC transformer that is connected to an AC power source.

FIG. 9 indicates that the PCD 920 may include a keyboard management module 982. The keyboard management module 982 may be a stand-alone controller or it may be within the memory 944. The keyboard management module 982 may be used to manage the operation of a virtual keyboard as described herein.

FIG. 9 further indicates that the PCD 920 may also include a network card 988 that may be used to access a data network, e.g., a local area network, a personal area network, or any other network. The network card 988 may be a Bluetooth network card, a WiFi network card, a personal area network (PAN) card, a personal area network ultra-low-power technology (PeANUT) network card, or any other network card well known in the art. Further, the network card 988 may be incorporated into a chip, i.e., the network card 988 may be a full solution in a chip, and may not be a separate network card 988.

As depicted in FIG. 9, the touch screen display 932, the video port 938, the USB port 942, the camera 948, the first stereo speaker 954, the second stereo speaker 956, the microphone 960, the FM antenna 964, the stereo headphones 966, the RF switch 970, the RF antenna 972, the keypad 974, the mono headset 976, the vibrator 978, and the power supply 980 are external to the on-chip system 922.

In a particular aspect, one or more of the method steps described herein may be stored in the memory 944 as computer program instructions. These instructions may be executed by a processor 924, 926 in order to perform the methods described herein. Further, the processors 924, 926, the memory 944, the keyboard management module 982, the display controller 928, the touch screen controller 930, or a combination thereof may serve as a means for executing one or more of the method steps described herein in order to control a virtual keyboard displayed at the display/touch screen 932.

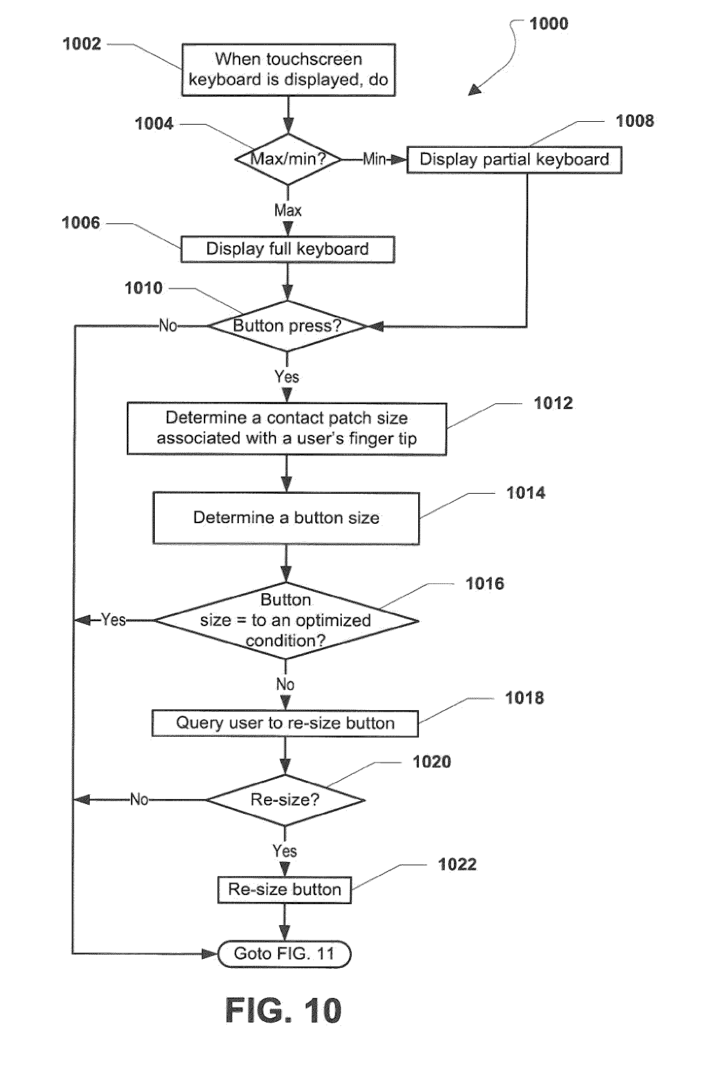

Referring now to FIG. 10 through FIG. 12, a method of managing a virtual keyboard is shown and is generally designated 1000. Commencing at block 1002, a do loop may be entered in which when a virtual keyboard is displayed on a touch screen interface, the following steps may be performed. At decision 1004, a keyboard management module may determine whether a maximum keyboard configuration or a minimum keyboard configuration is selected. If a maximum keyboard configuration is selected, the method 1000 may proceed to block 1006 and a maximum keyboard configuration, i.e., a full keyboard, may be displayed to the user at the touch screen interface. Conversely, if a minimum keyboard configuration is selected, the method 1000 may proceed to block 1008 and a minimum keyboard configuration, i.e., a partial keyboard, may be displayed to the user at the touch screen interface.

From block 1006 or block 1008, the method 1000 may proceed to decision 1010 and the keyboard management module may detect whether a button has been pressed. If so, the method 1000 may continue to block 1012 and the keyboard management module may determine a contact patch size associated with the user's finger tip. In another aspect, the contact patch size may be associated with the tip of a stylus. The contact patch size may be determined by determining which portion of the touch screen display is activated when the user touches the touch screen with his or her finger, or stylus, and determining the area of that portion of the touch screen that is activated when touched by the user.

Moving to block 1014, the keyboard management module may determine a size of the button pressed by the user. At decision 1016, the keyboard management module may determine whether the button size is equal to an optimized condition. The keyboard management module may determine whether the button size is equal to the optimized condition by comparing the contact patch size with the button size. The button size may be considered optimized if the button size is at least same as the contact patch size, but no greater than one and one-half times the size of the contact patch size.

The optimization of the button sizes may vary depending on the type of button and the presence of other buttons near a particular button. For example, a button such as a space button may have a much larger size, e.g., two times, three times, etc., of the contact patch of the user finger. Other buttons that are less frequently used, e.g., number buttons may be optimized when they are in a range of seventy-five percent (75%) and one hundred twenty-five percent (125%) of the contact patch size. When greater room exists between adjacent buttons, the optimization may be in a range of one hundred percent (100%) and two hundred percent (200%) of the contact patch size.

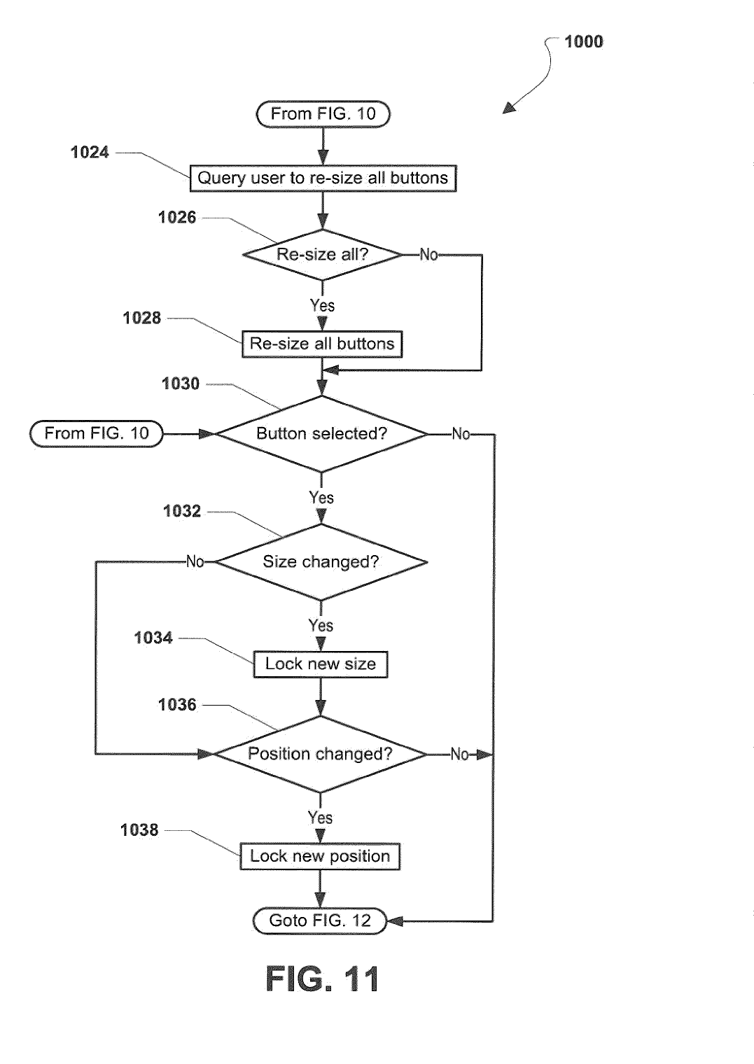

If the button size is not equal to an optimized condition, the method 1000 may move to block 1018 and keyboard management module may query the user to re-size the button. At decision 1020, the keyboard management module may determine whether the user wishes to re-size the button, e.g., based on the query. If so, the method 1000 may proceed to block 1022 and the button may be re-sized so that the button size satisfies the optimized condition described above. Thereafter, the method 1000 may proceed to block 1024 of FIG. 11.

Returning to decision step 1010, if a button is not pressed, the method 1000 may move directly to decision 1030 of FIG. 11. Further, returning to decision 1016, if the button size satisfies the optimized condition, the method 1000 may also proceed directly to decision 1030 of FIG. 11. Returning to decision 1020, if the user does not wish to re-size the button, the method 1000 may proceed to block 1024 of FIG. 11.

At block 1024 of FIG. 11, the keyboard management module may query the user to re-size all buttons. At decision 1026, the keyboard management module may determine whether the user wishes to re-size all buttons, e.g., based on the query. If so, the method 1000 may move to block 1028 and all buttons may be re-sized so that the size of each button satisfies the optimized condition. Thereafter, the method 1000 may move to decision 1030. Returning to decision 1026, if the user does not choose to re-size all buttons, the method 1000 may proceed directly to decision 1030.

At decision 1030, the keyboard management module may determine whether a button is manually selected, e.g., by double tapping the button. If a button is selected, the method 1000 may proceed to decision 1032 and the keyboard management module may determine whether a size of the button has been changed, e.g., manually. A user may manually change the size of a button by dragging a corner of a button, dragging a slider, inputting a size, or a combination thereof.

If the size of the selected button is changed, the method 1000 may proceed to lock 1034 and the new size of the button may be locked by the keyboard management module. Then, the method 1000 may proceed to decision 1036. Returning to decision 1032, if the size is not changed, the method 1000 may move directly to decision 1036.

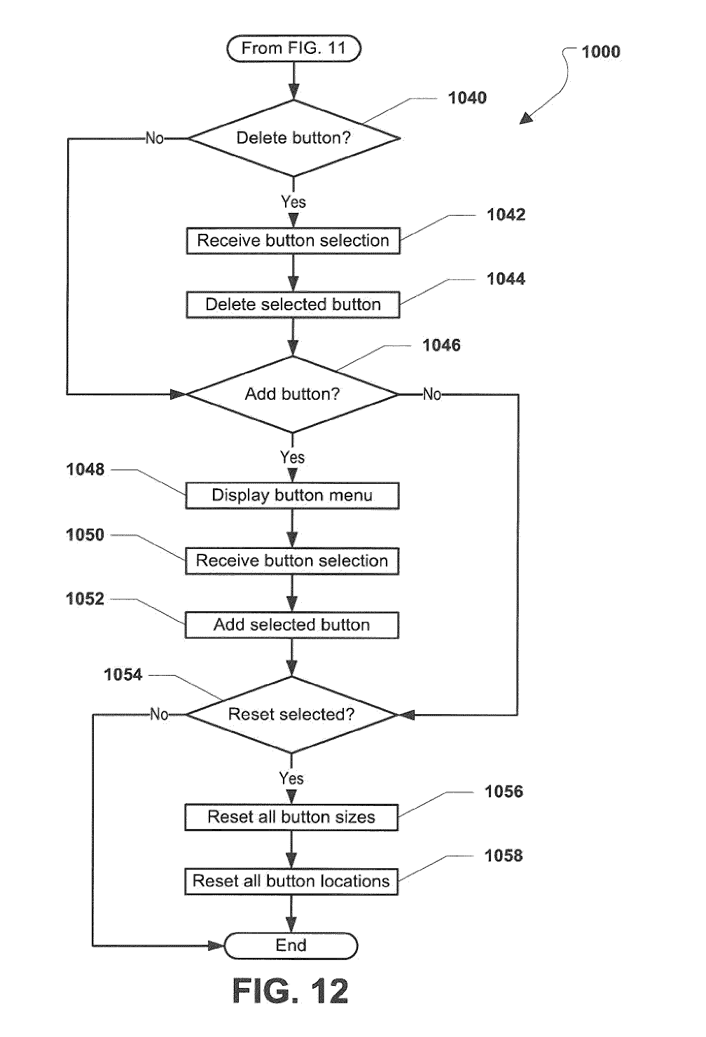

At decision 1036, the keyboard management module may determine a position of the selected button is changed. The position may be changed by dragging to the selected button to a new location on the virtual keyboard. If the position is changed, the method 1000 may proceed to block 1038 and the keyboard management module may lock the new position of the selected button. Returning to decision 1036, if the position is not changed, the method 1000 may proceed directly to decision 1040 of FIG. 12. Moreover, returning to decision 1030, if a button is not selected, the method 1000 may move also move directly to decision 1040.

At decision 1040, the keyboard management module may determine whether the user has selected a delete button option. If so, the method 1000 may continue to block 1042 and the keyboard management module may receive a button selection. Thereafter, the keyboard management module may delete the selected button at block 1044. The method 1000 may then continue to decision 1046. Returning to decision 1040, if the user has not selected a delete button option, the method 1000 may move directly to decision 1046.

At decision 1046, the keyboard management module may determine whether the user has selected an add button option. If so, the method 1000 may continue to block 1048 and the keyboard management module may display a button menu. Thereafter, at block 1050, the keyboard management module may receive a button selection. At block 1052, the keyboard management module may add the selected button. The method 1000 may then continue to decision 1054. Returning to decision 1046, if the user has not selected an add button option, the method 1000 may move directly to decision 1054.

At decision 1054, the keyboard management module may determine whether the user has selected a reset option. If so, the method 1000 may continue to block 1056 and the keyboard management module may reset the size of each button to a factory size or a provisioned size. Next, at block 1058, the keyboard management module may reset the location of each button to a factory location or a provisioned location. The method 1000 may then end. Returning to decision 1054, if the user does not select a reset option, the method 1000 may end.

It is to be understood that the method steps described herein need not necessarily be performed in the order as described. Further, words such as “thereafter,” “then,” “next,” etc. are not intended to limit the order of the steps. These words are simply used to guide the reader through the description of the method steps.

With the configuration described herein, the keyboards disclosed herein provide a more ergonomic keyboard than traditional linear QWERTY keyboards. The arced shape of each quadrantal portion allows a user to move his or her thumbs in a natural angular motion, provided by the carpometacarpal (CMC) joints of the thumb, when utilizing the keyboard. Further, by optimizing the size of the virtual buttons of the keyboard based on the contact patch size of the user's thumb (or finger), the ease of using the keyboard is substantially increased. Moreover, the shape of the keyboard disclosed herein minimizes the amount of display screen used by the keyboard when presented as a virtual keyboard on a touch screen display. Additionally, the locations of buttons, or the layout of the buttons, may be customized to meet individual needs.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A keyboard for a portable computing device (PCD), the keyboard comprising:
a first quadrantal portion disposed on a left side of a central axis, wherein the first quadrantal portion spans approximately zero degrees to approximately ninety degrees and wherein the first quadrantal portion comprises a first plurality of keyboard buttons; and
a second quadrantal portion disposed on a right side of a central axis, wherein the second quadrantal portion spans approximately ninety degrees to one hundred eighty degrees and wherein the second quadrantal portion comprises a second plurality of keyboard buttons.

2. The keyboard of claim 1, wherein the first plurality of keyboard buttons within the first quadrantal portion are arranged in a first plurality of arced button rows and wherein the second plurality of keyboard buttons within the second quadrantal portion are arranged in a second plurality of arced button rows.

3. The keyboard of claim 2, wherein the first plurality of arced button rows are concentric around a vertex of the first quadrantal portion and wherein the second plurality of arced button rows are concentric around a vertex of the second quadrantal portion.

4. The keyboard of claim 3, wherein the first plurality of arced button rows comprises: a first arced button row, a second arced button row, a third arced button row, a fourth arced button row, a fifth arced button, a sixth arced button row, or a combination thereof.

5. The keyboard of claim 4, wherein the first arced button row comprises a first button labeled “ENTER”; the second arced button row comprises a first button labeled “!@*” and a second button labeled “SHIFT”; the third arced button row comprises a first button labeled “Z”, a second button labeled “X”, a third button labeled “C”, and a fourth button labeled “V”; the fourth arced button row comprises a first button labeled “A”, a second button labeled “S”, a third button labeled “D”, a fourth button labeled “F”, and a fifth button labeled “G”; the fifth arced button row comprises a first button labeled “Q”, a second button labeled “W”, a third button labeled “E”, a fourth button labeled “R”, and a fifth button labeled “T”; the sixth arced button row comprises a first button labeled “1”, a second button labeled “2”, a third button labeled “3”, a fourth button labeled “4” and a fifth button labeled “5”; or any combination thereof.

6. The keyboard of claim 5, wherein the first quadrantal portion further comprises a first space button.

7. The keyboard of claim 3, wherein the second plurality of arced button rows comprises: a first arced button row, a second arced button row, a third arced button row, a fourth arced button row, a fifth arced button, a sixth arced button row, or a combination thereof.

8. The keyboard of claim 7, wherein the first arced button row comprises a first button labeled “ENTER”; the second arced button row comprises a first button labeled “SHIFT” and a second button labeled “FUNC”; the third arced button row comprises a first button labeled “B”, a second button labeled “N”, a third button labeled “M”, and a fourth button labeled “RETURN”; the fourth arced button row comprises a first button labeled “H”, a second button labeled “J”, a third button labeled “K”, a fourth button labeled “L”, and a fifth button labeled “CLEAR”; the fifth arced button row comprises a first button labeled “Y”, a second button labeled “U”, a third button labeled “I”, a fourth button labeled “O”, and a fifth button labeled “P”; the sixth arced button row comprises a first button labeled “6”, a second button labeled “7”, a third button labeled “8”, a fourth button labeled “9” and a fifth button labeled “O”; or any combination thereof.

9. The keyboard of claim 8, wherein the second quadrantal portion further comprises a second space button.

10. The keyboard of claim 1, wherein the keyboard is a virtual keyboard, wherein the first plurality of keyboard buttons comprises a first plurality of soft buttons, and wherein the second plurality of keyboard buttons comprises a second plurality of soft buttons.

11. The keyboard of claim 10, wherein the keyboard is movable between a maximized configuration in which all soft buttons are displayed and a minimized configuration in which a portion of soft buttons are displayed.

12. The keyboard of claim 1, wherein the keyboard is a mechanical keyboard, wherein the first plurality of keyboard buttons comprises a first plurality of mechanical buttons, and wherein the second plurality of keyboard buttons comprises a second plurality of mechanical buttons.

13. The keyboard of claim 1, further comprising a space button between the first quadrantal portion and the second quadrantal portion.

14. The keyboard of claim 13, further comprising a mouse pad between the first quadrantal portion and the second quadrantal portion.

15. A method for managing a virtual keyboard, the method comprising:
detecting whether a button is pressed; and
determining a contact patch size associated with a user thumb pressing the button.

16. The method of claim 15, further comprising:
determining a button size associated with the button.

17. The method of claim 16, further comprising:
determining whether the button size satisfies an optimized condition.

18. The method of claim 17, further comprising:
querying a user to re-size the button when the button size does not satisfy the optimized condition.

19. The method of claim 18, further comprising:
automatically re-sizing the button so the button size satisfies the optimized condition.

20. The method of claim 19, further comprising:
querying a user to re-size all buttons; and
automatically re-sizing all buttons based on an optimized button size.

21. The method of claim 17, further comprising:
comparing the contact patch size to the button size in order to determine whether the button size satisfies the optimized condition.

22. The method of claim 20, wherein the button size is optimized when the button size is at least same as the contact patch size.

23. The method of claim 21, wherein the button size is optimized when the button size is no greater than one and one-half times the contact patch size.

24. A portable computing device, comprising:
means for detecting whether a button is pressed; and
means for determining a contact patch size associated with a user thumb pressing the button.

25. The portable computing device of claim 24, further comprising:
means for determining a button size associated with the button.

26. The portable computing device of claim 25, further comprising:
means for determining whether the button size satisfies an optimized condition.

27. The portable computing device of claim 26, further comprising:
means for querying a user to re-size the button when the button size does not satisfy the optimized condition.

28. The portable computing device of claim 27, further comprising:
means for automatically re-sizing the button so the button size satisfies the optimized condition.

29. The portable computing device of claim 28, further comprising:
means for querying a user to re-size all buttons; and
means for automatically re-sizing all buttons based on an optimized button size.

30. The portable computing device of claim 26, further comprising:
means for comparing the contact patch size to the button size in order to determine whether the button size satisfies the optimized condition.

31. The portable computing device of claim 30, wherein the button size is optimized when the button size is at least same as the contact patch size.

32. The portable computing device of claim 31, wherein the button size is optimized when the button size is no greater than one and one-half times the contact patch size.

33. A portable computing device, comprising:
a processor, wherein the processor is operable to:
detect whether a button is pressed; and
determine a contact patch size associated with a user thumb pressing the button.

34. The portable computing device of claim 33, wherein the processor is further operable to:
determine a button size associated with the button.

35. The portable computing device of claim 34, wherein the processor is further operable to:
determine whether the button size satisfies an optimized condition.

36. The portable computing device of claim 35, wherein the processor is further operable to:
query a user to re-size the button when the button size does not satisfy the optimized condition.

37. The portable computing device of claim 36, wherein the processor is further operable to:
automatically re-size the button so the button size satisfies the optimized condition.

38. The portable computing device of claim 37, wherein the processor is further operable to:
query a user to re-size all buttons; and
automatically re-size all buttons based on an optimized button size.

39. The portable computing device of claim 35, wherein the processor is further operable to:
compare the contact patch size to the button size in order to determine whether the button size satisfies the optimized condition.

40. The portable computing device of claim 39, wherein the button size is optimized when the button size is at least same as the contact patch size.

41. The portable computing device of claim 40, wherein the button size is optimized when the button size is no greater than one and one-half times the contact patch size.

42. A computer program product, comprising:
a computer-readable medium, comprising:
at least one instruction for detecting whether a button is pressed; and
at least one instruction for determining a contact patch size associated with a user thumb pressing the button.

43. The portable computing device of claim 42, wherein the computer-readable medium further comprises:
at least one instruction for determining a button size associated with the button.

44. The portable computing device of claim 43, wherein the computer-readable medium further comprises:
at least one instruction for determining whether the button size satisfies an optimized condition.

45. The portable computing device of claim 44, wherein the computer-readable medium further comprises:
at least one instruction for querying a user to re-size the button when the button size does not satisfy the optimized condition.

46. The portable computing device of claim 45, wherein the computer-readable medium further comprises:
at least one instruction for automatically re-sizing the button so the button size satisfies the optimized condition.

47. The portable computing device of claim 46, wherein the computer-readable medium further comprises:
at least one instruction for querying a user to re-size all buttons; and
at least one instruction for automatically re-sizing all buttons based on an optimized button size.

48. The portable computing device of claim 44, wherein the computer-readable medium further comprises:
at least one instruction for comparing the contact patch size to the button size in order to determine whether the button size satisfies the optimized condition.

49. The portable computing device of claim 48, wherein the button size is optimized when the button size is at least same as the contact patch size.

50. The portable computing device of claim 49, wherein the button size is optimized when the button size is no greater than one and one-half times the contact patch size.
